(19) United States
(12) Patent Application Publication
(10) Pub. No.: US 2014/0268373 A1
(43) Pub. Date: Sep. 18, 2014

(54) COMFORTABLE FINGER MOUNTED OPTICAL DEVICE

(71) Applicant: Jerry Selness, San Diego, CA (US)

(72) Inventor: Jerry Selness, San Diego, CA (US)

(21) Appl. No.: 14/214,863

(22) Filed: Mar. 15, 2014

Related U.S. Application Data
(60) Provisional application No. 61/800,189, filed on Mar. 15, 2013.

(51) Int. Cl. G02B 25/00

(52) U.S. Cl. CPC G02B 25/002
USPC 359/815

(57) ABSTRACT

A comfortable finger mounted optical device requiring an optical device, at least one bonding holder, strap, or elastic band sized to receive any finger(s) or thumb, and a base plate or case. The comfortable finger mounted optical device can have many different variations including, but not limited to, the incorporation of split rings, straps, elastic bands, sleeves, Fresnel lens, or pivotal or slidable lens assemblies. In addition, the comfortable finger mounted optical device can have various attachments including, but not limited to, advertisements, an elastic cover, or LED's. This device is useable, convenient, as well as comfortable and snug-fitting.

### RELATED APPLICATION

The present invention claims the benefit of priority to U.S. Provisional Application Ser. No. 61/800,189, filed on Mar. 15, 2013, entitled Comfortable Finger Mounted Optical Device, and currently co-pending.

### FIELD OF THE INVENTION

The present invention relates generally to an improved finger accessory for optical enhancement. The present invention is more particularly, but not exclusively, a finger accessory with an optical device which is comfortable, convenient, and made for short-term or long-term use.

### BACKGROUND

Previously, optical enhancement devices such as a magnifying glass, which consist of a piece of curved glass or other light altering implement surrounded by a frame, have been equipped with attachments which allow for attachment to a thumb, finger, or other part of the hand. Such attachments have included a thimble (U.S. Pat. No. 672,179), clamps (U.S. Pat. No. 1,025,057 and U.S. Pat. No. 1,681,874), a lattice-like extending frame (U.S. Pat. No. 2,100,239), a base with a ball and socket member (U.S. Pat. No. 3,428,286), and a loop (U.S. Pat. No. 1,944,567). Though these prior inventions have achieved useful forms, these previous implementations have not addressed the issue of comfortable and long-term use necessary for work associated with such devices. Such prior applications unnecessarily trade comfort for usability and convenience. Additionally, devices disclosed in other prior patents, such as U.S. Pat. No. 4,133,603 and U.S. Pat. No. 7,339,7355, incorporate more simple designs, reducing cost and possibly improving the level of comfort marginally, but are limited in use. Further, other inventions disclosed in prior patents, such as U.S. Pat. No. 6,120,157 and U.S. Pat. No. 5,621,566, may have somewhat improved the level of comfort, but are used for a different purpose.

### SUMMARY

An improved finger accessory for optical enhancement conforms and sits comfortably on the finger(s) while optimizing stability and utility. The bonding holder is developed using materials that flex or emphasize attachment by friction rather than constriction in order to retain comfort and usefulness without causing reduced blood flow or distress to the skin during use. This also allows the device to enhance ease of mounting, dismounting, and use which is key for short-term, long-term, and rapid multitasking associated with scanning and reading magnified images of fine print or detail without having to use or change glasses.

### DRAWINGS

The objects, features, and advantages of the Comfortable Finger Mounted Optical Device will be more apparent to those skilled in the art after considering the following detailed description, when read in conjunction with the accompanying drawings, in which:

FIG. 1A is a perspective view of the left side of a thimble-sleeve embodiment, constructed in accordance with the invention.

FIG. 1B is a side view of the left side of the thimble-sleeve embodiment showing placement of a finger within the bonding holder.

FIG. 1C is a top view of the hand and thimble-sleeve embodiment showing placement of a finger within the bonding holder and relative placement of the invention to the hand when in use.

FIG. 2A is a perspective view of the left side of a finger-sleeve embodiment, constructed in accordance with the invention.

FIG. 2B is a side view of the left side of the embodiment showing placement of the finger within the bonding holder with the tip of the finger extending beyond the forward end of the sleeve and stabilized by the base plate of the invention.

FIG. 2C is a top view of the hand and finger-sleeve embodiment showing placement of a finger within the bonding holder and relative placement of the invention to the hand when in use.

FIG. 2D is a perspective view of the finger-sleeve embodiment showing the bonding holder held by the hand with the thumb and two fingers.

FIG. 3A is a perspective view of the left side of a hook and loop strap embodiment, constructed in accordance with the invention.

FIG. 3B is a perspective view of the hook and loop strap embodiment with an open and disengaged hook and loop strap located on the bottom of the base plate of the invention.

FIG. 3C is a side view of the left side of the embodiment showing placement of a finger within the hook and loop strap bonding holder. The hook and loop strap is engaged around a midsection of the finger with the tip of the finger stabilized by the base plate of the invention.

FIG. 3D is a top view of the hand and hook and loop strap embodiment showing placement of a finger within the bonding holder and relative placement of the invention to the hand when in use.

FIG. 3E is a perspective view of the hook and loop strap embodiment with an open and disengaged hook and loop strap located on the top of the base plate of the invention.

FIG. 4A is a perspective view of the left side of a dual hook and loop strap embodiment, constructed in accordance with the invention, with one strap engaged and one disengaged.

FIG. 4B is a side view of the left side of the embodiment showing placement of a finger within the bonding holder with both straps engaged about midsections of the finger and stabilized by the base plate of the invention.

FIG. 4C is a top view of the hand and hook and loop embodiment showing placement of a finger within the bonding holder with both straps engaged around midsections of the finger and relative placement of the invention to the hand when in use.

FIG. 5A is a perspective view of the left side of a split ring thimble-like embodiment, constructed in accordance with the invention.

FIG. 5B is a side view of the left side of the embodiment showing placement of a finger within the bonding holder.

FIG. 5C is a top view of the hand and split ring thimble-like embodiment showing placement of a finger within the bonding holder and relative placement of the invention to the hand when in use.

FIG. 6A is a perspective view of the left side of a split ring thimble-like embodiment with an extended base plate with a hole for tethering the invention.

FIG. 6B is a side view of the left side of the split ring thimble-like embodiment showing placement of a finger within the bonding holder.

FIG. 6C is a top view of the hand and split ring thimble-like embodiment showing placement of a finger within the bonding holder and relative placement of the invention to the hand when in use.

FIG. 7A is a perspective view of the left side of a dual, fixed-ring embodiment, constructed in accordance with the invention.

FIG. 7B is a side view of the left side of the dual, fixed-ring embodiment showing placement of a finger within the bonding holder.

FIG. 7C is a top view of the hand and dual, fixed-ring embodiment showing placement of a finger within the bonding holder and relative placement of the invention to the hand when in use.

FIG. 8A is a perspective view of the left side of a finger-sleeve embodiment with a Fresnel optical element, constructed in accordance with the invention.

FIG. 8B is a side view of the left side of the Fresnel, finger-sleeve embodiment showing placement of a finger within the bonding holder with the tip of the finger extending beyond the bonding holder and stabilized by the base plate.

FIG. 8C is a top view of the hand and Fresnel, finger-sleeve embodiment showing placement of a finger within the bonding holder and relative placement of the invention to the hand when in use.

FIG. 8D is a top view of the hand and rectangular-shaped Fresnel, finger-sleeve embodiment showing placement of a finger within the bonding holder and relative placement of the invention to the hand when in use.

FIG. 9A is a perspective view of the left side of an elastic-sleeve embodiment constructed in accordance with the invention.

FIG. 9B is a side view of the left side of the elastic-sleeve embodiment showing placement of a finger within and extending beyond the bonding holder, stabilized by the base plate.

FIG. 9C is a top view of the hand and elastic-sleeve embodiment showing placement of the finger within and extending beyond the bonding holder and relative placement of the invention to the hand when in use.

FIG. 9D is a perspective view of the elastic-sleeve embodiment showing the elastic band gripped by the hand with the thumb and two fingers.

FIG. 9E is a side view of the left side of the elastic-sleeve embodiment showing placement of a finger within and extending beyond the bonding holder, with a tab that secures the bonding holder about the base plate of the invention.

FIG. 9F is a side view of the left side of the elastic-sleeve embodiment with a magnet, constructed in accordance with the invention.

FIG. 10A is a perspective view of the left side of a dual finger-sleeve embodiment with a retractable optical element, constructed in accordance with the invention.

FIG. 10B is a side view of the left side of the embodiment showing placement of multiple fingers within the fully encompassing bonding holder.

FIG. 10C is a top view of the hand and dual finger-sleeve embodiment showing placement of multiple fingers within the bonding holder and relative placement of the invention to the hand when in use.

FIG. 11A is a perspective view of the left side of an open, dual finger-sleeved embodiment with open-ended sleeves to support a larger optical element, constructed in accordance with the invention.

FIG. 11B is a side view of the left side of the open, dual finger-sleeved embodiment showing placement of multiple fingers within the bonding holder.

FIG. 11C is a top view of the hand and open, dual-finger-sleeved embodiment showing placement of multiple fingers within the bonding holder and relative placement of the invention to the hand when in use.

FIG. 12A is a perspective view of the left side of a lighted, dual finger-sleeved embodiment with a power switch, and a larger optical element, constructed in accordance with the invention.

FIG. 12B is a bottom view of the lighted, dual finger-sleeved embodiment showing placement of a power switch, light emitting diode (LED) lights, and solar panel.

FIG. 12C is a side view of the left side of the lighted, dual finger-sleeved embodiment showing placement of multiple fingers within the bonding holder and propagation of light from the LEDs.

FIG. 12D is a top view of the hand and lighted, dual finger-sleeved embodiment showing placement of multiple fingers within the bonding holder and relative placement of the invention to the hand when in use.

FIG. 13 is a perspective view of an elastic-sleeve embodiment of the invention when in use reading a document on a flat surface.

FIG. 14 is a perspective view of an open, dual finger-sleeved embodiment of the invention when in use reading a document on a flat surface.

FIG. 15A is a side view of a finger-sleeve embodiment of the invention which incorporates advertisements, logos, or any printing along the side of the bonding holder.

FIG. 15B is a perspective view of the left side of a finger-sleeve embodiment of the invention which incorporates advertisements, logos, or any printing along the top or bottom of the base plate between the optical element and bonding holder, and on the bonding holder itself.

FIG. 15C is a perspective view of the left side of an engaged hook and loop strap embodiment of the invention which incorporates advertisements, logos, or any printing on the backing of an exposed portion of the strap.

FIG. 15D is a perspective view of the left side of a disengaged hook and loop strap embodiment of the invention which incorporates advertisements, logos, or any printing on the backing of a portion of the strap which is not exposed when engaged.

FIG. 15E is a perspective view of the left side of an open, dual finger-sleeved embodiment of the invention which incorporates advertisements, logos, or any printing on the bonding holder.

FIG. 15F is a bottom view of an open, dual finger-sleeved embodiment which incorporates a large advertisement, logo, or printing on the bottom of the exposed surface of the invention.

FIG. 16A is a perspective view of the left side of an elastic-sleeve embodiment, with an elastic cover, which is partially attached to the bottom side of the base plate, constructed in accordance with the invention.

FIG. 16B is a side view of the left side of the embodiment showing placement of a finger within and extending beyond both the elastic band, stabilized by the base plate, and an elastic cover, constructed in accordance with the invention.

FIG. 16C is a top view of the hand and elastic-sleeve embodiment showing placement of the finger within and extending beyond both the elastic band and relative placement of the invention to the hand when in use, and elastic cover, constructed in accordance with the invention.

FIG. 16D is a top view of the hand and elastic-sleeve embodiment showing placement of the finger within and extending beyond the elastic band and relative placement of the invention to the hand when in use, and with the elastic cover folded around the front end of the base plate, covering the optical element.

FIG. 16E is a right side view of an alternative elastic cover embodiment, where the cover is folded and does not have a grip, and showing the direction in which the cover can extend to cover an optical element.

FIG. 16F is a right side view of an elastic cover embodiment, where the cover is folded and has a grip at the folding point.

FIG. 16G is a perspective view of the left side of the alternative elastic cover embodiment of FIG. 16E, showing the adhesive which attaches the cover to the bottom of the base plate and stitching which forms a pocket that receives the front of the base plate.

FIG. 16H is a perspective view of the left side of the elastic cover embodiment of FIG. 16F with additional stitching, showing the adhesive which attaches the cover to the bottom of the base plate and additional stitching which forms a pocket that receives the front of the base plate.

FIG. 17A is a perspective view of the left side of an alternative elastic-sleeve embodiment with an extended pivotal lens assembly, constructed in accordance with the invention.

FIG. 17B is a side view of the right side of the embodiment showing the pivotal lens assembly, retracted and positioned within the base unit of the invention.

FIG. 17C is a side view of the left side of the embodiment showing placement of the finger within the bonding holder with the tip of the finger extending beyond the forward end of the elastic band and stabilized by the top of the case of the invention, with the pivotal lens assembly extended.

FIG. 17D is a top view of the elastic-sleeve embodiment utilized to read a document where the lens assembly has a rectangular-shaped optical element extending from the case at a 90 degree angle.

FIG. 18A is a side view of the left side of an alternative elastic-sleeve embodiment showing placement of the finger within the elastic band with the tip of the finger extending beyond the forward end of the elastic band and stabilized by the case of the invention, with the unibody center pivotal lens assembly extended.

FIG. 18B is a top view of the hand and the elastic-sleeve embodiment showing placement of a finger within the elastic band and relative placement of the invention to the hand when in use, with the unibody center pivotal lens assembly extended.

FIG. 18C is a top view of the embodiment showing the unibody center pivotal lens assembly retracted and positioned within the base unit.

FIG. 18D is a top view of the embodiment showing the unibody center pivotal lens assembly extended.

FIG. 18E is a side view of the left side of the embodiment which is inverted with the unibody center pivotal lens assembly extended.

FIG. 18F is a side view of the left side of the embodiment which is inverted with the unibody center pivotal lens assembly extended and without the counter balance portion.

FIG. 19A is a perspective view of the left side of an open, dual finger-sleeved embodiment with open-ended sleeves to support a larger optical element and an extended slidable lens assembly, constructed in accordance with the invention.

FIG. 19B is a perspective view of the left side of the embodiment with a retracted slidable lens assembly, constructed in accordance with the invention.

FIG. 19C is a top view of the embodiment showing the slibable lens assembly extended.

FIG. 19D is a side view of the left side of the embodiment showing the slidable lens assembly extended.

### DETAILED DESCRIPTION

The present invention incorporates traditional convex magnifying glasses, Fresnel-like lenses, and any other compact optical element technologies known in the art. The structures used to attach the optical enhancement technology to the finger allow the benefit of ease of use, mounting, dismounting, manipulation, and comfort which current finger-mounted devices do not currently enjoy. In FIG. 1A, a perspective view of a thimble-sleeve embodiment of the invention is shown and generally designated 100. Device 100 includes a base plate 102 with a front end 104 and a rear end 106. Embedded or attached within the front end 104 of the base plate 102 is an optical element 108, such as a magnifying lens which is designed to magnify images located below the lens 108. Attached, molded, or glued to the rear end 106 of the base plate 102 is the thimble-sleeve bonding holder 110. The thimble-sleeve bonding holder 110 is designed with a finger-sized aperture 112, then tapered to a closed end to conform to the tip end of any finger 114 (FIG. 1B) or thumb. The optical element 108 is positioned just beyond the end of the bonding holder 110, and thus the tip end of the finger 114 (FIG. 1B), in order to facilitate scanning and reading of magnified images of fine print. Materials and dimensions envisioned, but not limited, for the thimble-sleeve bonding holder 110 in this embodiment 100 consist of flexible or rigid materials which are known in the art to sufficiently attach to the tip end of the finger 114 (FIG. 1B) without the device slipping off. Materials for the thimble-sleeve are contemplated as, but not limited to, metal or plastic. Further, the use of multiple materials and layers such as a hard outer thimble, with a soft textured inner surface are also contemplated.

In FIG. 1B, a side view of the thimble-sleeve embodiment 100 shows the relative placement of the finger 114 within the thimble-sleeve bonding holder 110. The thimble-sleeve embodiment 100 shows how the device sits on the tip end of the finger 114 and allows for a user to see magnified images from the optical element 108 while scanning documents with their finger 114. This view also shows the curvature of an optical element 108 such as a piano-convex lens, embedded or attached just beyond the tip end of the finger 114 and bonding holder 110.

In FIG. 1C, a top view of the hand with tip end of finger 114 engaged with the thimble-sleeve embodiment 100, it can be seen that the device as a whole is designed to be compact and lightweight with the base plate 102 being no longer than necessary to accommodate the thimble-sleeve bonding holder 110 and the optical element 108. The compactness facilitates its use when scanning items and this is further reflected in the placement of the optical element 108 just beyond the bonding holder 110 and finger 114. The thimble-sleeve bonding holder 110 itself is also sized to what is necessary to provide secure but comfortable attachment to the finger 114.

Referring to FIG. 2A, an alternative embodiment of the invention is shown and generally designated 150. Like the thimble-sleeve embodiment 100, an optical element 158 is attached or embedded at the front end 154 of the base plate 152. In this finger-sleeve embodiment of the device, the finger-sleeve bonding holder 160 consists of flexible, sung-fitting materials like but not limited to, cloth, leather, or lined leather, which extends around the rear end 156 and is attached or bonded to the bottom side of the base plate 152. The finger-sleeve bonding holder 160 is designed with a finger-sized aperture 162, sized to conform to provide secure but comfortable attachment to any finger 164. As shown in FIGS. 2B and 2C, the finger 164 sits on top of the base plate 152 and extends beyond the bonding holder 160 exposing the tip end of the finger 164. The finger-sleeve embodiment 150 is capable, however, of being used without inserting finger 164 through the finger-sized aperture 162 and into the bonding holder 160. For example, the bonding holder 160 of the finger-sleeve embodiment 150 can be held by the hand with the thumb and two fingers (FIG. 2D). In addition, like other embodiments, this embodiment, as shown in FIG. 2A, can include a hole 168 through base plate 152, equidistant to the sides of the device, and of sufficient size and proximity to the edge of rear end 156 of base plate 152 as to accommodate a mode of tethering such as a key chain or locket chain 166, for example.

Referring to FIG. 3A, an alternative embodiment of the invention is shown and generally designated 200. Like the other embodiments (100 and 150), an optical element 208, such as a magnifying glass, is attached or embedded to the front end 204 of the base plate 202. In this hook and loop strap embodiment 200, the straps are attached to bottom of the rear end 206 of the base plate 202 with a hook side 212 and a loop side 210 extending away from the left and right sides of the device (FIG. 3B), respectively. The hooks found on the hook side 212 are positioned on the bottom side of the strap (FIG. 3B), while the loops found on the loop side 210 are positioned on the top side of the strap (FIG. 3B). When engaged, the loop side 210 is placed over the hook side 212, and are positioned in order to secure the device to any finger 214 (FIG. 3C) and align the optical element 208 just beyond the end of the tip end of any finger 214 so that the user can scan and read magnified images of fine print. It is important that the size of the base plate is sized to the extent necessary (FIG. 3D) to house the optical element and the attachment of the bonding holder strap which consists of hook side 212 and loop side 210. Alternatively, the straps may be attached to top of the rear end 206 of the base plate 202 (FIG. 3E). In addition, like other embodiments, this embodiment can include a hole 218 through base plate 202, equidistant to the sides of the device, and of sufficient size and proximity to the edge of rear end 206 of base plate 202 as to accommodate a mode of tethering such as a key chain or locket chain, as shown in FIGS. 3A, 3B, 3D, and 3E.

Referring to FIG. 4A, an alternative embodiment of the invention is shown and generally designated 250. This dual hook and loop strap embodiment 250 builds on the hook and loop strap embodiment 200 by using a second set of hook side 262 and loop side 260 straps spaced a moderate ways apart from the hook side 266 and loop side 264 straps at the rear end 256 of the base plate 252. The finger 268 is aligned on the base plate 252 so that the optical element 258 is located just beyond the tip end and both sets of straps are engaged, loop side [260, 264] over hook side [262, 266], so a comfortable but secure attachment can be made to the finger 268 as shown in FIG. 4C. The hook and loop straps in the hook and loop strap embodiments may also be fully wrapped in hook and loop material to serve as a soft handle, either to pick up the device or comfortably place any finger within the straps. It is appreciated that there are variations, as to orientation, of the hook and loop straps which keep within the spirit of the description.

Referring to FIG. 5A, an alternative embodiment of the invention is shown and generally designated 300. In this split ring thimble-like embodiment 300 of the device, an optical element 308 is attached or embedded in the front end 304 of the base plate 302. The split ring thimble-like bonding holder is formed with a finger-tip curved plate 310 with extensions 312 and 314 forming a partially closed aperture 316 which is formed to fit the tip end of the finger 318 (FIG. 5B). The curved plate 310 tapers to a blunt point and gradually rises away from the base plate 302 toward the optical element 308, matching the curvature of the tip end of the finger 318. The split ring design of the extensions 312 and 314 allow one size to fit many fingers if the extensions 312 and 314 are made from a material that is flexible enough, such as, but not limited to, soft flexible plastic. A stop 315 is formed on the base plate between the optical element and the extensions 312 and 314 such that the user's finger will not extend forward and obstruct the viewing through the optical element. The bonding holder is attached or bonded to the base plate 302 at the rear end 306 and the overall dimensions of the base plate 302 are designed to place the optical element 308 just beyond the tip end of the finger 318 when secured fully within the split ring thimble-like bonding holder (FIG. 5C) to facilitate scanning the fine detail. It is contemplated that the split ring thimble-like bonding holder can be made from, but not limited to, flexible soft plastic.

Referring to FIG. 6A, an alternative embodiment of the invention is shown and generally designated 350. In this split ring thimble-like embodiment 350, the base plate 352 has an tapered and extended portion 358 which contains a hole 360, equidistant to the sides of the device, and of sufficient size and proximity to the edge of the tapered end as to accommodate a mode of tethering such as a key chain or locket chain. Like the previous embodiments discussed, the base plate has a front end 354 to which an optical element 362 is attached or embedded. A split ring thimble-like bonding holder, consisting of a curved plate 364 with two peripheral extensions, 366 and 388, which form a partially closed aperture 370, shaped to fit the tip end of a finger 372 (FIG. 6B), is attached to the rear end 356 of the base plate 352. This split ring design allows one size to fit many fingers. The tapered end of the curved plate 364 is aligned toward the optical element 362 and the aperture 370 is perpendicularly aligned toward the hole 360.

Referring to FIG. 7A, an alternative embodiment of the invention is shown and generally designated 400. In this dual, fixed-ring embodiment 400, the optical element 408 is attached or embedded to the front end 404 of the base plate 402. A forward ring 410 and rear ring 412 are attached or formed with a holder plate 414. The holder assembly consisting of plate 414, forward ring 410, and rear ring 412 are then attached, bonded, or formed with the base plate 402 at the rear end 406. It is contemplated that the base plate and holder assembly could be made from, but not limited to, wood, acrylic, or polycarbonate, and rings could be made of rubber. The forward ring 410 and rear ring 412 are sufficiently spaced to allow for secure attachment to the finger when in use with the finger 416 aligned so the optical element 408 is just beyond the tip end (FIGS. 7B and 7C). The base plate 402 and holder assembly (410, 412, 414) can be molded in one piece construction.

Referring to FIG. 8A, an alternative embodiment of the invention is shown and generally designated 450. In this finger-sleeve embodiment with Fresnel lens 450, the optical element 458 is a Fresnel lens formed as an extension or attachment to the base plate 452 at the front end 454. The finger-sleeve bonding holder 460 is made of a flexible material like cloth, leather, lined leather, or hook and loop and is attached to the bottom or top side of the rear end 456 of the base plate 452. The finger-sleeve bonding holder 460 has a finger-sized aperture 462 which tapers slightly from rear end 456 to front end 454 to conform to the shape of a finger and when fully engaged, a portion of the tip end of the user's finger 464 is exposed an aligned so the optical element 458 is just beyond the fingertip (FIG. 8C). The Fresnel lens 458 in this embodiment applies techniques known in the art for molding or forming of grooves necessary to magnify object below the lens 458. The finger-sleeve embodiment with Fresnel lens 450 can have a Fresnel lens of any size, shape, and dimension known in the art, such as a rectangular-shaped Fresnel lens 459 (FIG. 8D), for example. It is also contemplated that the Fresnel lens 458 or 459 and base plate 452 can be molded as one piece.

Referring to FIG. 9A, an alternative embodiment of the invention is shown and generally designated 500. In this elastic-sleeve embodiment of the device 500, like other single finger embodiments, the optical element 508, such as a magnifying glass, is attached or embedded in the front end 504 of the base plate 502. An elastic band 510 is attached, bonded, or molded at the inner diameter of the band, to the bottom side of the base plate 502 near the rear end 506. The elastic band 510 can be formed by materials such as, but not limited to, polyester and rubber or polyester and rubber and polyester monofilament, and consists of a finger-sized aperture 512. The band aperture 512 is designed to allow a finger 514 to be engaged within the elastic band 510 while aligned just short of the optical element 508 as depicted in FIGS. 9B and 9C. Like other embodiments, such as the finger-sleeve embodiment 150 shown in FIG. 2D, the elastic-sleeve embodiment 500 is capable of being used without inserting finger 514 through the finger-sized band aperture 512 into the elastic band 510. For example, the elastic band 510 of the elastic-sleeve embodiment 500 can be can be held by the hand with the thumb and two fingers (FIG. 9D). The elastic-sleeve embodiment 500 can optionally include a tab 516 to secure the elastic band 510 about the base plate 502 (FIG. 9E). Additionally, the elastic-sleeve embodiment 502, or any other embodiment, can optionally include a magnet 518 (FIG. 9F) to secure the device to another magnetic material, such as a refrigerator, for example, to store for later use. As shown in FIGS. 9E and 9F, both the tab 516 and magnet 518 are attached to the bottom side of the base plate 502.

Referring to FIG. 10A, an alternative embodiment of the invention is shown and generally designated 550. In this dual finger-sleeve embodiment of the device 550, a pocket 554 made of materials like cloth or leather, is formed with an aperture 560 sufficient to accommodate the full width of two fingers, terminating in a right, closed-end snug-fitting sleeve 556 and a left, closed-end snug-fitting sleeve 558. The bottom of the fingertip end of the pocket 554 is attached or bonded to the top of a flip open holder case 552. This case 552 has a hinge or pivot pin 568 which attaches a pivoting lens assembly consisting of a lens holder 562, an optical element 564 such as a magnifying lens, and a fingertip-like notch 566 in the lens holder, designed to facilitate retraction or extension of the lens assembly from the case 552. The case and assembly are contemplated as being made of standard materials well known in the art including, but not limited to, hard plastic or metal for the case, and plastic or metal for the hinge or pivot pin. By using a two-finger pocket 554, a larger lens 564 can be accommodated while still allowing the use of two other fingers and a thumb, useful for tasks like map reading. Both the middle finger 570 and the index finger 572 are completely encompassed by the form fitting pocket 554 as depicted in FIGS. 10B and 10C. One variation of the pocket design is shown for the index finger 572 and middle finger 570 in FIG. 10C, showing the relative size and shape of the lens assembly and case 552 to the hand as a whole. It is to be understood, however, that any two fingers may be used with the two-finger pocket 554.

Referring to FIG. 11A, a perspective view of an alternative embodiment of the invention is shown and generally designated 600. In this open, dual finger-sleeved embodiment 600 of the device, a right sleeve 612 and a left sleeve 614 are formed with finger-sized apertures, 616 and 618, respectively. The sleeves 612 and 614 are attached to the top of base plate 602, and extend from the rear end 606 to the front end 604. It is contemplated that the sleeves 612 and 614 may be hook and loop material. When fully engaged, the middle finger 624 and index finger 626 extend a small portion outside of the front end of the sleeves 612 and 614, but short of the optical element 608 (FIGS. 11B and 11C). The optical element 608, such as a magnifying glass, is attached, bonded, or molded with a post 610 that is attached, bonded, or molded to the front end 604 of the base plate 602. Protective guards 620 and 622 are formed or molded as extensions of the front end 604 of the base plate 602, and follow the curvature of the optical element 608. It is contemplated that the post 610, base plate 602, and guards 620 and 622 may all be molded as one piece and hold the optical element 608. This two-finger embodiment allows greater control and steadiness to accommodate a larger optical element 608 while allowing two free fingers and thumb for gripping or doing other things.

Referring to FIG. 12A, a perspective view of an alternative embodiment of the invention is shown and generally designated 650. In this lighted, dual finger-sleeved embodiment 650, two LEDs 670 (FIGS. 12B and 12C) are mounted to the front end 654 of the case 652. The case contains wiring, mounting of LEDs 670 (FIGS. 12B and 12C) and a solar panel 674 (FIG. 12B). Installed on the left side of the rear end 656 of the case 652, is a switch 668 that toggles whether the LED circuit is active or not. It is contemplated, however, that the switch 668 may be located on either side of the rear end 656 or front end 654 of case 652. The LEDs 670 are installed at an angle suitable for illuminating 672 objects located within the optical element's intended range of use. The solar panel is mounted, embedded, or attached to the bottom side of the case 652, opposite the top side where finger-sleeves 660 and 662 are located. The finger sleeves 660 and 662 consist of a mildly flexible material like cloth, hook and loop, or leather, generally in the size of a finger for a snug fit. The sleeves 660 and 662 consist of a finger-sized aperture 664 and 666, respectively, and extend toward the front end 654 of the case 652. When fully engaged, the middle finger 676 and index finger 678 are partially encompassed by the sleeves 660 and 662, with a small portion of the tip end of the user's fingers extending beyond the sleeves but short of the optical element 658. It is to be understood, however, that any two fingers can be used and encompassed by the sleeves 660 and 662. An optical element 658 such as a magnifying glass is attached to the front end 654 of the case 652. The use of two fingers accommodates steadiness and control for a larger optical element 658 while still allowing two other fingers and a thumb to grip, provide steadiness for reading, or to do other things.

In FIG. 13, a perspective view is shown of a single finger embodiment 700 of the invention, in use. The single finger embodiment 700 is representative of the group of alternative embodiments comprising FIGS. 1-9. The single finger embodiment 700 has an optical element 702 which magnifies. The hand 704 depicted is shown supporting the height of the embodiment 700 by way of being braced and stabilized by the thumb and three fingers. The document 706 being “read” is on a fiat surface and contains a string of letters 708 which are visibly magnified 710 by the optical element 702. In general, for use, the optical element 702 is moved back and forth between the eye and the object to be read or viewed, seen magnified until the image is in focus, thus accommodating the user's eyes. When this accommodation occurs near a flat surface, the extra fingers and thumb can stabilize the scanning movement across the fiat surface.

In FIG. 14, a perspective view is shown of a two finger embodiment 750 of the invention, in use. The two finger embodiment 750 is representative of the group of alternative embodiments comprising FIGS. 10-12. The two finger embodiment 750 supports a larger optical element 752 and is braced by the hand 754 in a similar manner as the single finger embodiment 700 with the thumb and two fingers. The document 756 being “read” is on a flat surface and contains a string of numbers 758 in which a larger set of objects are magnified 760 in comparison to the single finger embodiment 700. As discussed above, for general use, the optical element 752 is moved back and forth between the eye and the object to be read or viewed, seen magnified until the image is in focus, thus accommodating the user's eyes. When this accommodation occurs near a flat surface, the extra fingers and thumb can stabilize the scanning movement across the flat surface.

FIGS. 15A-F show a set of modifications to several previously discussed embodiments which include the location and appearance of printing such as advertisements, logos, or text. As used herein, the term advertisements is defined to include but not be limited to any text, logo, artwork, image, design, dimpling, braile and other markings which provide information to the observer.

FIG. 15A shows a side view of a single finger embodiment with “AD HERE” 800 written on the exposed surface of the bonding holder. FIG. 15B depicts a left side perspective view of a single finger embodiment showing two locations where printing could be located such as the word “AD” 808 located in the space between the bonding holder 802 and the optical element 804, and along the bottom of the exposed surface of the bonding holder 802 with “ADVERTISE HERE” 806. FIG. 15C is a left side perspective depicting an embodiment of the invention consisting of a base plate 810 and an optical element 812 attached or embedded without a finger engaged. An example of printing, “USA” 814 is located across the back end of a loop side strap 210 (FIG. 3A) of that particular embodiment. FIG. 15D depicts the embodiment consisting of a base plate 816 and optical element 818 attached or embedded without a finger engaged and the hook side strap 822 and loop side strap 820 unfurled. Printing of “AD” 824 can be located on the inside portion of the hook side strap 822 to promote a different message while device is disengaged. FIG. 15E is a left side perspective depicting a two finger embodiment of the invention with a two line example of printing on the top of the exposed bonding holder with “ADVERTISE” 826 on the right sleeve and “HERE” 828 on the left sleeve. FIG. 15F is a bottom view of a two finger embodiment of the invention with a base plate 830 and optical element 832. Located on the exposed bottom side of the base plate is a larger area for printing, denoted by the square border and words “LARGE AD HERE” 834.

Referring to FIG. 16A, a perspective view is shown of an alternate elastic-sleeve embodiment of the invention and generally designated 850. In this elastic-sleeve embodiment 850, an elastic cover 862 is partially attached to the bottom side of the base plate 852. In a preferred embodiment, a grip or tab 866 can be included at the front edge of the cover 862 (FIG. 16F) to facilitate removal of the cover 862 from covering the optical element 858, rather than having to directly pinch the front end 854 of the base plate 852. The cover 862 is positioned in the space between the optical element 858 and the elastic band 860, near the center of base plate 852, and is attached, bonded, or molded to the bottom side of the base plate 852. The cover 862 is mounted, embedded, or attached to the bottom side of the base plate 852 with an adhesive 868 located at the rear end of the top side of the cover 862 (FIGS. 16E-H). This adhesive can be contemplated as permanent or temporary. As discussed above for FIGS. 9A-F, the elastic band 860 is attached, bonded, or molded at the inner diameter of the band, to the bottom side of the base plate 852 near the rear end 856 (FIG. 16B).

Referring now to FIG. 16B, the finger 864 is aligned on the base plate 852 so that the optical element 858 is located just beyond the tip end of the finger 864. Similarly, the attached portion of cover 862 is aligned on the base plate 852 so that the optical element 858 is located just beyond the end of the portion of the cover 862 that is attached to the base plate 852, so that the cover 862 does not interfere with the use of the optical element 858 (FIG. 16C). To further prevent the cover 862 from interfering with the use of the optical element 858, two pieces of hook and loop material, 872 and 870 respectively, can be attached, sewn, or bonded to the bottom side of the cover 862 near the rear end and center of the cover 862 (FIGS. 16B, 16E, and 16F). It is irrelevant, however, if the loop side piece 870 is placed near the end of cover 862 and the hook side piece 872 is placed near the center of cover 862, or vice versa, as depicted in FIGS. 16E and 16F. These hook and loop pieces 870 and 872 allow the part of the cover 862 that is not attached to the base plate 852 to fasten to the part of the elastic cover 862 that is attached to the base plate 852, so that that part of the cover 862 is held back and does not interfere with the use of the optical element 858.

To cover the optical element 858, the cover 862 can extend and fold around the front end 854 of the base plate 852, so that the front portion of the cover 862 covers the optical element 858 (FIG. 16D). The cover 862 is capable of an extending linearly 874 to receive the front end 854 of base plate 852 since the cover is made of elastic or semi-elastic material (FIG. 16E). In a preferred embodiment, stitching 876 is added on the sides of the cover 862 (FIG. 16G) to form a pocket 878 in which the front end 854 of base plate 852 slides into to cover the optical element 858. Optionally, additional stitching 877 can be added laterally across the front edge of the cover 862 (FIG. 16H). In this embodiment, the elasticity of the cover 862 is important so that the cover can extend linearly 874 (FIG. 16E) in order uncover the front end 854 of the base plate 852.

Referring to FIG. 17A, an alternative embodiment of the invention is shown and generally designated 900. In this elastic-sleeve embodiment of the device 900, an elastic band 920 is attached or bonded to the top of a pivotal case 902. This case 902 has a hinge or pivot pin 916 at the front end 904 of the case 902, which attaches a pivoting lens assembly 910 consisting of a lens holder 912, an optical element 908 such as a magnifying lens, and a body 914. The hinge or pivot pin 916 goes through the body 914 of the lens assembly 910. The lens holder 912 and optical element 908 may vary in type, size or shape, such as a circular-shaped lens 908 shown in FIGS. 17A-C or a rectangular-shaped lens 909 as shown in FIG. 17D. The case 902 and assembly 910 are contemplated as being made of standard materials well known in the art including, but not limited to, hard plastic or metal for the case, and plastic or metal for the hinge or pivot pin 916. When retracted, the pivoting lens assembly 910 is positioned between the top and bottom of the case 902 (FIG. 17B), which provides protection and also makes it easier to carry. When ready to use, the pivoting lens assembly 910 rotates axially about the hinge or pivot pin 916 extending radially from front end 904 of the case 902 (FIG. 17C). The body 914 can also have a knurled edge 915, so that the user can easily rotate the lens assembly 910 with his or her thumb or finger when it is retracted (FIG. 17B). The pivoting lens assembly 910 may also extend from either side of case 902 at a 90 degree angle. As shown in FIG. 17D, the device 900 is shown being utilized to read a document 922, where the lens assembly 910 extends from the case 902 at a 90 degree angle, may be preferred in some cases such as when the optical element 909 is rectangular-shaped as shown in FIG. 17D instead of a circular optical element 908 shown in FIGS. 17A-C. This horizontal alignment of rectangular-shaped optical element 909 would allow the user to magnify more words in a horizontal line than if the rectangular-shaped optical element were aligned vertically. This embodiment 900 is also contemplated with a keychain loop 918 at the rear end 906 of the case 902 end as to accommodate a mode of tethering such as a key chain or locket chain 917 (FIG. 17A).

Referring to FIG. 18A, an alternative embodiment of the invention is shown and generally designated 950. In this elastic-sleeve embodiment of the device 950, an elastic band 970 is attached or bonded to the top of a pivotal case 952. This case 952 has a hinge or pivot pin 966 at the front end 954 of the case 952, which attaches a unibody center pivoting lens assembly 960 consisting of a lens holder 962, an optical element 958 such as a magnifying lens, and a unibody centerpiece 964, which includes a counter balance portion 965 near the opposite end of the lens assembly 960 that the lens holder 962 is on, designed to counter the weight of the lens holder 962 and optical element 958. In an alternative embodiment, the lens assembly 960 does not have the counter balance portion 965, as shown in FIG. 18F, so that that portion 965 does not extend past the front end 954 of the case 952 like it does in FIG. 18C. Thus, the case 952 and assembly 960 are almost identical to case 902 and assembly 910 in FIGS. 17A-C, except assembly 960 has a unibody center piece 964 which, with the hinge or pivot pin 966 through it, rotates axially about the assembly's 960 center instead of rotating about the end of assembly 910, like in FIGS. 17A-C. Accordingly, case 952 and assembly 960 are also contemplated as being made of standard materials well known in the art including, but not limited to, hard plastic or metal for the case 952, and plastic or metal for the hinge or pivot pin 966. When in use, the lens holder 962 and optical element 958 extend radially from the front end 954 of the case 952 (FIGS. 18A-B and 18D-E). The pivoting lens assembly 960 is positioned between the top and bottom of the case 952 and when retracted, the optical element 958 is protected by the case 952 (FIG. 18C). This embodiment 950 is also contemplated with a keychain loop 968 at the rear end 956 of the case 952 end as to accommodate a mode of tethering such as a key chain or locket chain.

Finally, in FIG. 19A, a perspective view of an alternative embodiment of the invention is shown and generally designated 1000. In this alternative open, dual finger-sleeved embodiment 1000 of the device, a right sleeve 1012 and a left sleeve 1014 are attached to the top of a slidable case 1002. A slidable lens assembly 1010 is capable of retraction or extension in direction 1005 from the case 1002. The optical element 1008, such as a magnifying glass, is embedded in the front end of the assembly 1010. The case 1002 and assembly 1010 are contemplated as being made of standard materials well known in the art including, but not limited to, hard plastic or metal. When retracted, the entire assembly 1010 is positioned within the case 1002 (FIG. 19B). When extended, the rear end of assembly 1010 stops at the front end 1004 of the case 1002 (FIGS. 19A and 19D) and the optical element 1008 is just beyond the front end 1004 of the case 1002 (FIG. 19C).

Several examples of materials used to make the structural elements of the invention are provided, but are understood not to be limiting. Materials used to form lenses include, acrylic, polycarbonate, or glass. The base plate has been contemplated as using acrylic or polycarbonate or homopolymer or metal, such as aluminum or titanium.

While there have been shown what are presently considered to be preferred embodiments and preferred applications of the present invention, it will be apparent to those skilled in the art that various changes and modifications can be made herein without departing from the scope and spirit of the invention.

I claim:

1. An optical device for enhancing or altering images to aid the user in the task of interpretation or reading, comprising:
a bonding holder configured to accept at least a portion of a finger;
a case comprising:
a top side, designed to receive and support the bonding holder;
a bottom side; a front end, having a pivot or hinge, wherein said pivot of hinge extends from the top side to the bottom side of said case; and
a rear end; and
a lens assembly comprising:
a front end, a center, and a rear end;
a lens holder, located at the front end of the lens assembly;
an optical element, wherein said optical element is attached or embedded to said lens holder; and
a body, designed to accept said pivot or hinge of the case, attaching said lens assembly to said case.

2. The optical device of claim 1 wherein said bonding holder is selected from one or more materials selected from the group of leather, lined leather, cloth, hook and loop, metal, elastic, and plastic.

3. The optical device of claim 1 wherein said body is positioned at the rear end of said lens assembly.

4. The optical device of claim 3 further comprising a knurled edge on said body designed to facilitate rotating said lens holder and said optical element from the case for use.

5. The optical device of claim 1 where the body is positioned at the center of the lens assembly.

6. The optical device of claim 5 further comprising a counter weight integrally attached to the end of the body opposite that of the lens holder.

7. An optical device for enhancing or altering images to aid the user in the task of interpretation or reading, comprising:
an optical element;
a bonding holder, designed to accept at least a portion of a finger, said bonding holder comprising flexible materials;
a base plate comprising:
a top side;
a bottom side;
a front end, encompassing said optical element; and
a rear end, designed to receive and support said bonding holder; and
an elastic cover configurable to cover said optical element, comprising:
a top side and a bottom side;
a front portion, having a pocket designed to receive said front end of the base plate; and
a rear portion, attached on the top side of said elastic cover to the bottom side of the base plate.

8. The elastic cover of claim 7 further comprising a grip or tab aligned laterally across the end of the front portion of said elastic cover to facilitate easy removal of the cover.

9. The elastic cover of claim 7 further comprising a fastener attached on the bottom side of said base plate adjacent said rear portion of said elastic cover configured to retain said elastic cover adjacent said base.

10. The elastic cover of claim 7 wherein the elastic cover is selected from a group of materials comprising of elastic and semi-elastic.

11. An optical device for enhancing or altering images to aid the user in the task of interpretation or reading, comprising:
an optical element;
a bonding holder, designed to accept at least a portion of a finger, said bonding holder comprising flexible materials; and
a base plate comprising:
a top side;
a bottom side;
a front end, designed to encompass or receive the optical element; and
a rear end, designed to receive and support the bonding holder.

12. The optical device of claim 11 where said bonding holder is a tubular finger sleeve which extends to the rear end and is attached to said bottom side of said base plate.

13. The optical device of claim 12 further comprising a hole in the base plate sized to accommodate a tether.

14. The optical device of claim 12 where said optical element is a Fresnel lens.

15. The optical device of claim 12 further comprising advertisements.

16. The optical device of claim 11 wherein the bonding holder is a hook and loop fastener strap configured to form a loop sized to received at least a portion of a finger.

17. The optical device of claim 16 wherein the hook and loop fastener strap is attached to the top side of the base plate.

18. The optical device of claim 16 wherein the hook and loop fastener strap is attached to the bottom side of the base plate.

19. The optical device of claim 16 further comprising a hole in the base plate for accommodating a mode of tethering such as a key chain or locket chain.

20. The optical device of claim 16 further comprising advertisements.

21. An optical device for enhancing or altering images to aid the user in the task of interpretation or reading, comprising:
an optical element;
a bonding holder, designed to accept at least a portion each of two fingers; and
a base plate comprising:
a top side;
a bottom side;
a front end, configured to encompass or receive the optical element; and
a rear end, configured to receive and support said bonding holder.

22. The optical device of claim 21 where the bonding holder is two tubular finger sleeves which extend to the rear end and is attached to the bottom side of the base plate.

23. The optical device of claim 22, wherein said base plate is comprised of a case, with a source of light illuminating the target of the optical device, a system for power is attached or embedded, and a system for toggling that power flow for the device.

24. The two finger held optical device of claim 22 further comprising advertisements.

25. An optical device for enhancing or altering images to aid the user in the task of interpretation or reading, comprising:
an optical element;
a base formed with a cavity configured to receive said optical element in a first configuration wherein said optical element is within said cavity, and a second configuration wherein said optical element is at least partially outside said cavity; and
a bonding holder attached to said base.
